(19) United States
(12) Patent Application Publication
(10) Pub. No.: US 2005/0281463 A1
(43) Pub. Date: Dec. 22, 2005

(54) Method and apparatus for processing binary image

(75) Inventor: Jong-hyon Yi, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/110,790

(22) Filed: Apr. 21, 2005

(30) Foreign Application Priority Data
Apr. 22, 2004 (KR) 2004-27893
May 6, 2004 (KR) 2004-31852

(51) Int. Cl. G06K 9/34

(52) U.S. Cl. 382/173

(57) ABSTRACT

A method and an apparatus for processing a binary image are disclosed. The method comprises the steps of: a) dividing the binary image input from an image source into a plurality of image blocks; b) extracting feature information from each of the image blocks; and c) determining the type of images constructing each of the image blocks by using the extracted feature information. The compression rate of binary images is increased by using different compression algorithm according to classified images.

### CROSS-REFERENCE TO RELATED APPLICATIONS

This application claims the benefit under 35 U.S.C. § 119(a) of Korean Patent Application No. 2004-27983, filed Apr. 22, 2004, and No. 2004-31852, filed May 6, 2004, the entire disclosures of which are hereby incorporated by reference.

### BACKGROUND OF THE INVENTION

1. Field of the Invention

The present invention relates to a method and an apparatus for processing a binary image. More particularly, the present invention relates to a method and an apparatus for processing a binary image by classifying images included in the binary image into an image suitable for a symbol matching encoding algorithm and an image unsuitable for a symbol matching encoding algorithm.

2. Description of the Related Art

Various algorithms for compressing a binary image without loss are known. Examples include: Modified Huffman (MH), Modified Relative Element Address Designate (Modified READ, or MR), Modified Modified Relative Element Address Designate (modified modified READ, or MMR), and the algorithm set forth in the Joint Bi-level Image expert Group (JBIG) standard. The CCITT Group 3 and Group 4 fax standards use the MR and the MMR algorithms. The JBIG algorithm is an arithmetic encoding algorithm which encodes images based on the context of the images. Recently, the JBIG2 standard has been approved. The encoding method specified by the JBIG2 standard is capable of encoding images both with and without loss. The JBIG2 standard adopts an encoding method based on symbol matching.

In a symbol matching encoding method, symbols are extracted from an input image. A dictionary, or library, is searched to find symbols similar to the extracted symbols. After searching, if there are similar symbols in the dictionary, the image is encoded by using an index to an entry in the dictionary. If there are no similar symbols, the extracted symbol is added to the dictionary.

The symbol matching encoding method effectively encodes so-called symbol regions, or regions containing such items as text data. The symbol matching encoding method is ineffective, however, for encoding so-called halftone regions, or regions containing images such as line art or halftone images. This happens because the compression ratio decreases when the symbol matching encoding method is used to encode an image including line art or halftone images. Generally, a binary image document includes not only symbol regions, but also halftone regions. Accordingly, if the symbol matching encoding method is used for encoding a binary image having both symbol regions and halftone regions, the compression ratio decreases. Therefore, the symbol matching encoding method is not effective for encoding a document containing both symbol regions and half-tone regions.

To overcome the above-mentioned problem, an image can be segmented into different regions using algorithms such as a Run Length Smearing Algorithm (RLSA), a Recursive X-Y Cut (RXYC) algorithm, or a Docstrum algorithm. These algorithms, however, require complicated computations and large amounts of memory. Therefore, these algorithms have been used primarily for text recognition or for analyzing the structure of text.

Furthermore, the segmentation of a binary image using the above-mentioned conventional methods produces symbols in the boundary between divided image blocks. The symbols in the boundary may generate singletons. Also, the compression rate decreases when the above-mentioned conventional methods are used to encode a binary image.

Accordingly, there is a need for an improved method and apparatus for encoding a binary image.

### SUMMARY OF THE INVENTION

An aspect of the present invention is to solve at least the above problems and/or disadvantages and to provide at least the advantages described below. Accordingly, an aspect of the present invention is to provide a method and apparatus for effectively encoding a binary image by classifying images forming the binary image into images suitable for a symbol matching encoding method and images unsuitable for a symbol matching encoding method.

Another aspect of the present general inventive concept is to provide a method and apparatus for effectively encoding a binary image by effectively extracting symbols from a binary image in order to use the extracted symbols for symbol matching.

To achieve the above-described aspects of the present invention, a method for processing a binary image comprises the steps of: a) dividing a binary image input from an image source into a plurality of image blocks; b) extracting feature information from each of the image blocks; and c) classifying the type of image forming each of the image blocks by using the extracted feature information.

The images constructing each of image blocks may be classified as one of a text image or a halftone image in the step c).

The method may further comprise the step of d) isolating halftone images from the binary image by performing a Recursive XY Cut algorithm.

The feature information may include the number of connected components included in each of the image blocks or the rate of color change between pixels in each of the image blocks.

The step d) may comprise the steps of: d-1) generating a first feature value representing the amount of included text images in each of the image blocks based on the number of connected components and the rate of color change, and generating a second feature value representing the amount of included halftone images in each of the image blocks based on the number of connected components and the rate of color change; and d-2) comparing the first feature value and the second feature value.

The types of images included in each image block may be classified as a text image when the image block has a first feature value larger than a second feature value or as a halftone image when a first feature value is smaller than a second feature value.

The first feature value may be inversely proportional to the number of connected components and the rate of color change and the second feature value may be proportional to the number of connected components and the rate of color change.

In accordance with another aspect of the present invention, an apparatus for processing a binary image is provided. The apparatus comprises an information extracting unit for dividing a binary image received from an image source into a plurality of image blocks and extracting feature information from each of the image blocks, and an image classifying unit for classifying the images forming each of the image blocks based on the extracted feature information.

The image classifying unit may classify the images forming each of the image blocks as a text image or a halftone image.

The apparatus may further comprise an image isolating unit for isolating halftone images from the binary image by performing a Recursive XY Cut algorithm.

The information extracting unit may extract at least one of the number of connected components included in each of the image blocks or the rate of color change between pixels in each of the image blocks.

The image classifying unit may comprise a first feature value outputting unit for generating a first feature value representing the amount of text images included in each of the image blocks based on the number of connected components and the rate of color change; a second feature value outputting unit for generating a second feature value representing the amount of halftone images included in each of the image blocks based on the number of connected components and the rate of color change; and an image type determining unit for comparing the first feature value and the second feature value and classifying the type of image included in each of the image blocks as a text image or a halftone image.

The image type determining unit may classify images of an image block having a first feature value larger than a second feature value as a text image, and classify images of an image block having a first feature value smaller than a second feature value as a halftone image.

In accordance with another aspect of the present invention, a method for processing a binary image is provided. The method comprises the steps of: a) dividing a binary image input from an image source into a plurality of image blocks and classifying images constructing each of the image blocks into a symbol image and a non-symbol image; b) searching a symbol in a symbol image block including the symbol images; and c) tracing an outline of the searched symbol and extracting the symbol from the binary image when tracing of the outline of the searched symbol is completed.

The method may further comprise the step of d) determining whether a target symbol for tracing is included in a non-symbol image block having the non-symbol images and tracing an outline of the target symbol by crossing over the non-symbol image block when the target symbol is included in the non-symbol image block.

The method may further comprise the steps of: e) searching a dictionary to find a symbol similar to the extracted symbol; and f) registering the extracted symbol to the dictionary when the similar symbol is not in the dictionary.

In accordance with yet still another aspect of the present invention, an apparatus for processing a binary image is provided. The apparatus comprises an information extracting unit for dividing a binary image input from an image source into a plurality of image blocks and extracting feature information from each of the image blocks, an image classifying unit for classifying images constructing each of the image blocks into a symbol image or a non-symbol image, a symbol extracting unit for searching a symbol in a symbol image block having the symbol images, tracing an outline of the searched symbol and extracting the symbol from the binary image when tracing of the outline is completed.

The symbol extracting unit may determine whether a target symbol for tracing is included in a non-symbol image block and traces an outline of the target symbol by crossing over into the non-symbol image block when the target symbol is included in the non-symbol image block.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a block diagram illustrating an apparatus for processing a binary image in accordance with a first embodiment of the present invention;

FIG. 2 shows a binary image divided into image blocks by the information extracting unit in FIG. 1;

FIG. 3 is a detailed block diagram illustrating the image classifying unit in FIG. 1;

FIG. 4A is a graph showing the variation of a first text feature value according to the number of connected components, and FIG. 4B is a graph showing the variation of a second text feature value according to the rate of color change;

FIG. 5A is a graph showing the variation of a first halftone feature value according to the number of connected component, and FIG. 5B is a graph showing the variation of a second halftone feature value according to the rate of color change;

FIG. 6A is a graph showing the variation of a first intermediate feature value according to the number of connected components, and FIG. 6B is a graph showing the variation of a second intermediate feature value according to the rate of color change;

FIG. 7 is a flowchart showing a method for classifying images in accordance with an embodiment of the present invention;

FIG. 8 shows a binary image having a plurality of image blocks labeled to represent the type of images in each image block;

FIG. 9A shows a halftone image isolated by an image isolating unit, and FIG. 9B shows an image generated by performing a Recursive XY cut on the halftone image of FIG. 9A;

FIG. 10A illustrates a binary image where halftone images have been isolated, and FIG. 10B shows an isolated halftone image;

FIG. 11 shows a binary image where images unsuitable for a symbol matching encoding method have been isolated;

FIG. 12 is a block diagram illustrating an apparatus for processing a binary image in accordance with a second embodiment of the present invention;

FIG. 13 is a flowchart showing a method for processing a binary image in accordance with an embodiment of the present invention;

FIG. 14 shows a binary image divided into a plurality of image blocks based on the determination of the image classifying unit 340;

FIG. 15 shows a symbol tracing step of a symbol extracting unit of FIG. 12;

FIG. 16 illustrates an image where symbols are extracted; and

FIG. 17 shows a non-symbol image compressed by a second compressing unit of FIG. 12.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

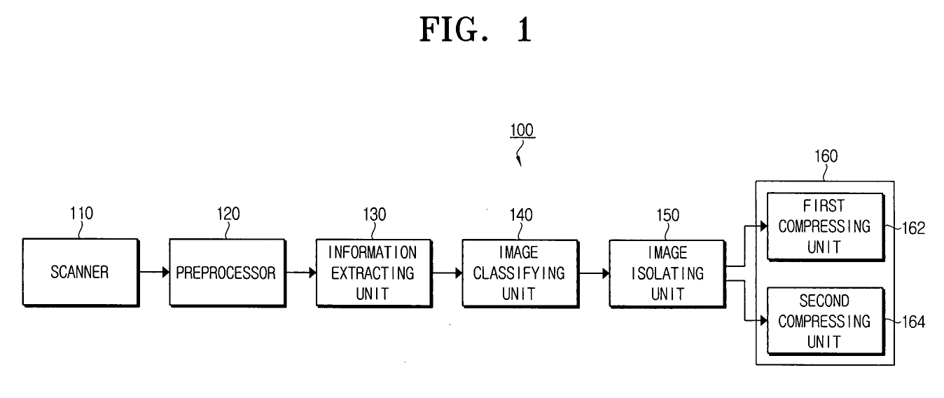

FIG. 1 is a block diagram illustrating an apparatus for processing a binary image in accordance with a first embodiment of the present invention. Referring to FIG. 1, the apparatus 100 for processing a binary image comprises a scanner 110, a preprocessor 120, an information extracting unit 130, an image classifying unit 140, an image isolating unit 150, and a compressing unit 160.

The apparatus 100 classifies binary images into images suitable or unsuitable for a symbol matching encoding algorithm, thereby effectively encoding a binary image input from an image source such as the scanner 110.

The scanner 110 scans a target document to generate a binary image of the target document and converts the binary image into a digital signal. After conversion, the scanner 110 outputs the digital signal to the preprocessor 120. The preprocessor 120 performs preprocessing such as noise filtering and gradient correction on a supplied image.

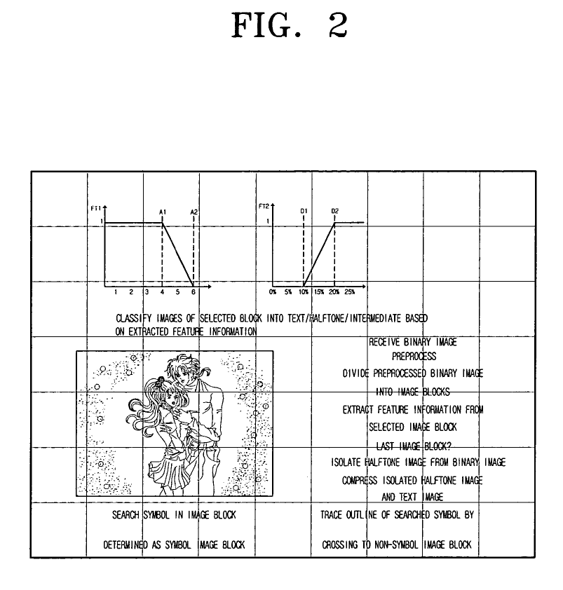

The information extracting unit 130 divides the preprocessed binary image into a plurality of image blocks having a predetermined size. FIG. 2 shows a binary image divided into image blocks by the information extracting unit 130 in FIG. 1. As shown in FIG. 2, the image blocks preferably do not overlap. The resolution of the binary image preferably determines the size of each image block.

The information extracting unit 130 extracts feature information from each of the image blocks. The extracted feature information includes the number of connected components in each of the image blocks and a rate of color change between image pixels in each image block. The information extracting unit 130 outputs the extracted feature information to the image classifying unit 140.

The image classifying unit 140 classifies the type of images included in each of the image block based on the extracted feature information.

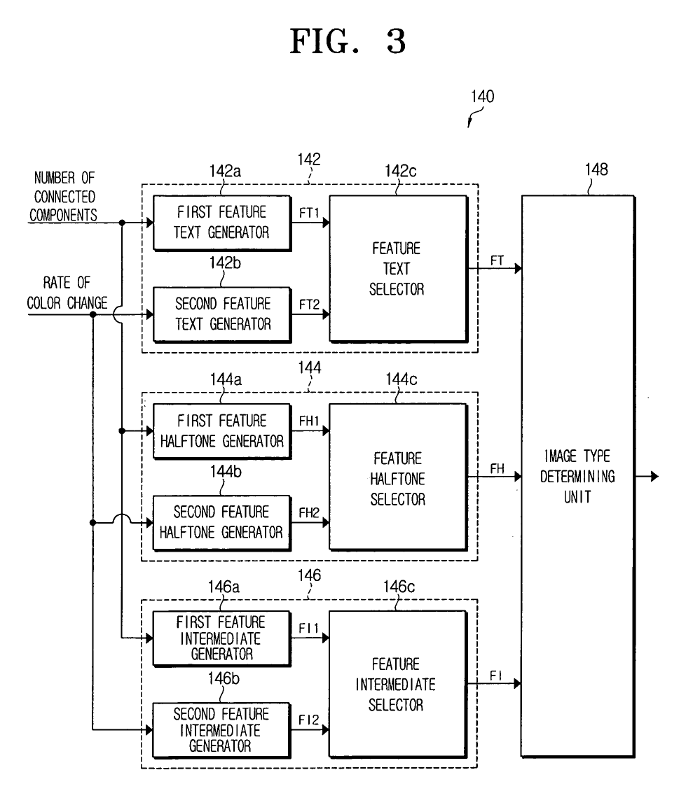

FIG. 3 illustrates the image classifying unit 140 in FIG. 1 in more detail. Referring to FIG. 3, the image classifying unit 140 comprises a first feature value outputting unit 142, a second feature value outputting unit 144, a third feature value outputting unit 146, and an image type determining unit 148.

The first, second, and third feature value outputting units 142, 144 and 146 generate first, second, and third feature values based on the feature information extracted by the information extracting unit 130. The extracted feature information includes the number of the connected components in each image block and the rate of color change between image pixels in each image block. The first feature value is a feature text (FT) value and the second feature value is a feature halftone (FH) value. The third feature value is a feature intermediate (FI) value. The FT value represents the amount of text images included in each of the image blocks and the FH represents the amount of halftone images included in each of the image blocks. The F1 represents the amount of unclassified images included in each of the image blocks. An unclassified image is an image not classified as a text image or as a halftone image.

The first feature value outputting unit 142 comprises a first feature text generator 142a, a second feature text generator 142b, and a feature text selector 142c. The second characteristic value outputting unit 144 comprises a first feature halftone generator 144a, a second feature halftone generator 144b, and a feature halftone selector 144c. The third feature value outputting unit 146 comprises a first feature intermediate generator 146a, a second feature intermediate generator 146b, and a feature intermediate selector 146c.

As mentioned above, the extracted feature information includes the number of connected components and the rate of color change. The number of connected components is input to the first feature text generator 142a, the first feature halftone generator 144a, and the first feature intermediate generator 146a. The rate of color change is input to the second feature text generator 142b, the second feature halftone generator 144b, and the second feature intermediate generator 146b.

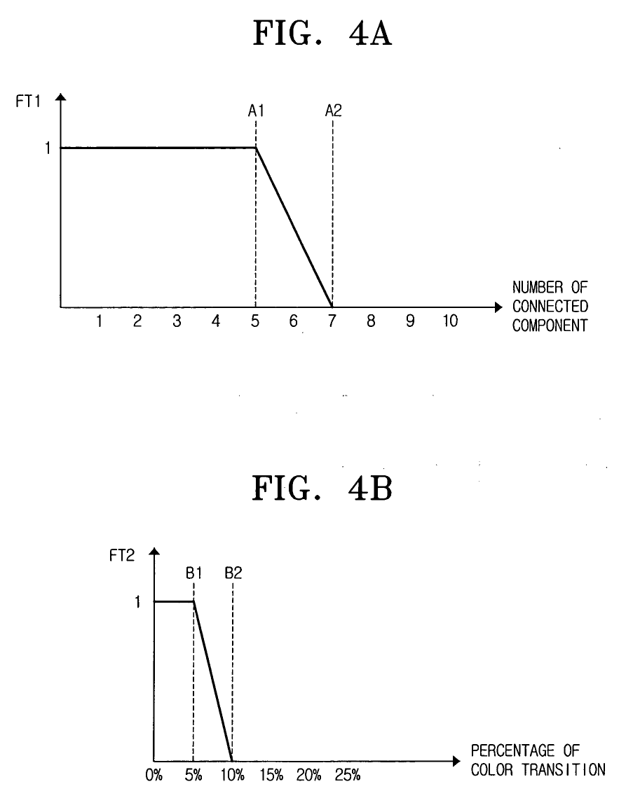

The first feature text generator 142a generates the first feature text value (FT1) by matching the number of connected components to the graph shown in FIG. 4A. In FIG. 4A, the ‘x’ axis represents the number connected components and the ‘y’ axis represents the first feature text values (FT1) according to the number of connected components. As shown in FIG. 4A, the first feature text value (FT1) gets larger as the number of the connected components gets smaller. In other words, the first feature text value (FT1) has a maximum value (1) when the number of the connected components is less than a first reference value (A1). In contrast, the first feature text value (FT1) has a minimum value (0) when the number of the connected components is larger than a second reference value (A2). When the number of the connected components is between the first reference value (A1) and the second reference value (A2), the first feature text value (FT 1) has a value inversely proportional to the number of the connected components.

The second feature text generator 142b generates the second feature text value (FT2) by matching the rate of color change to the graph shown in FIG. 4B. In FIG. 4B, the ‘x’ axis represents the rate of color change and the ‘y’ axis represents the second feature text value (FT2) according to the rate of color change. As shown in FIG. 4B, the second feature text value (FT2) gets larger as the rate of color change gets smaller. That is, the second feature text value (FT2) has a maximum value (1) when the rate of color change is less than a first reference value (B1). In contrast, the second feature text value (FT2) has a minimum value (0) when the rate of color change is larger than a second reference value (B2). When the rate of color change is between the first reference value (B1) and the second reference value (B2), the second feature text value (FT2) has a value inversely proportional to the rate of color change.

The feature text selector 142c compares the first feature text value (FT1) and the second feature text value (FT2) and outputs the larger value as a final feature text value (FT).

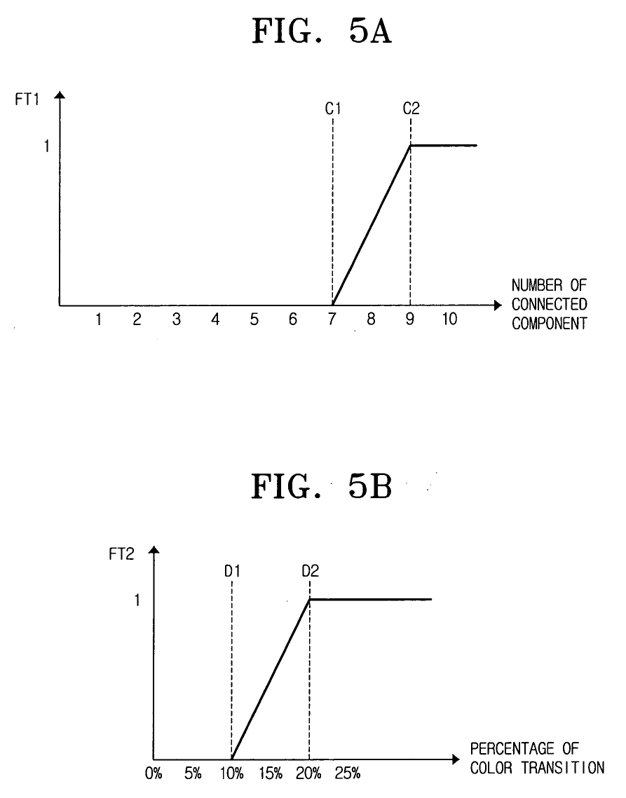

The first feature halftone generator 144a generates the first feature halftone value (FH1) by matching the number of connected components to the graph shown in FIG. 5A. In FIG. 5A, the ‘x’ axis represents the number of connected components and the ‘y’ axis represents the first feature halftone values (FH1) according to the number connected components. As shown in FIG. 5A, the first feature text value (FT1) gets larger as the number of connected components gets larger. In other words, the first feature halftone value (FH1) has a minimum value (0) when the number of connected components is less than a first reference value (C1). In contrast, the first feature halftone value (FT1) has a maximum value (1) when the number of the connected components is larger than a second reference value (C2). When the number of the connected components is between the first reference value (C1) and the second reference value (C2), the first feature halftone value (FH1) has a value proportional to the number of the connected components.

The second feature halftone generator 144b generates the second feature halftone value (FH2) by matching the rate of color change to the graph shown in FIG. 5B. In FIG. 5B, the ‘x’ axis represents the rate of color change and the ‘y’ axis represents the second feature halftone values (FH2) according to the rate of color change. As shown in FIG. 5B, the second feature halftone value (FH2) gets larger as the rate of color change gets larger. For example, the second feature halftone value (FH2) has a minimum value (0) when the rate of color change is less than a first reference value (D1). In contrast, the second feature halftone value (FH2) has a maximum value (1) when the rate of color change is larger than a second reference value (D2). When the rate of color change is between the first reference value (D1) and the second reference value (D2), the second feature halftone value (FH2) has a value proportional to the rate of color change.

The feature halftone selector 144c compares the first feature halftone value (FH1) and the second feature halftone value (FH2) and outputs the larger value as the final feature halftone value (FH).

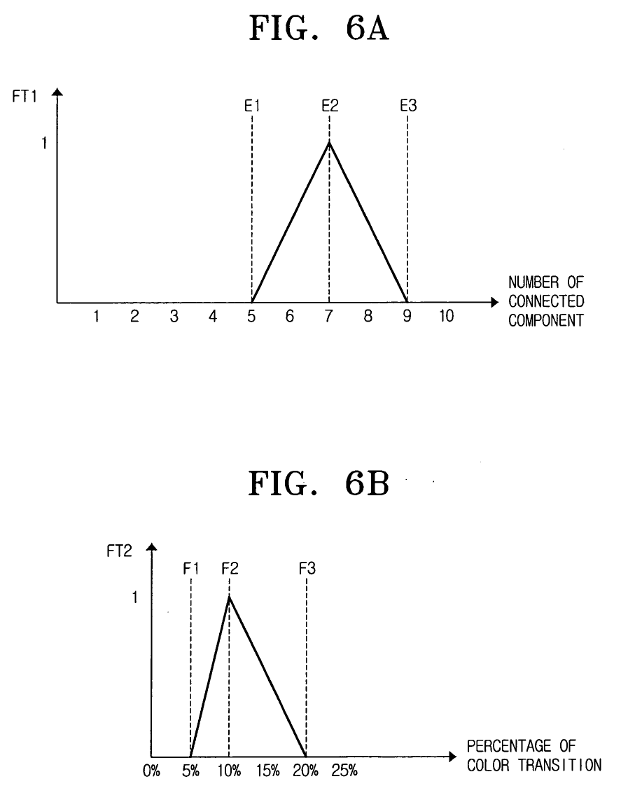

The first feature intermediate generator 146a generates the first feature intermediate value (FI1) by matching the number of connected components to the graph shown in FIG. 6A. In FIG. 6A, the ‘x’ axis represents the number of connected components and the ‘y’ axis represents the first feature intermediate values (F11) according to the number of connected components. As shown in FIG. 6A, the first feature intermediate value (FI1) has a minimum value (0) when the number of connected components is less than a first reference value (E1) or when the number of connected components is larger than a third reference value (E3). The first feature intermediate value (FI1) has a maximum value (1) when the number of connected components is a second reference value (E2). In contrast, when the number of the connected components is between the first reference value (E1) and the second reference value (E2), the first feature intermediate value (FI1) has a value proportional to the number of the connected components. When the number of the connected components is between the second reference value (E2) and the third reference value (E3), the first feature intermediate value (FI1) has a value inversely proportional to the number of the connected components.

The second feature intermediate generator 146b generates the second feature intermediate value (FI2) by matching the rate of color change to the graph shown in FIG. 6B. In FIG. 6B, the ‘x’ axis represents the rate of color change and the ‘y’ axis represents the second feature intermediate values (FI2) according to the rate of color change. As shown in FIG. 6B, the second feature intermediate value (FI2) has a minimum value (0) when the rate of color change is less than a first reference value (F1) or when the rate of color change is larger than a third reference value (F3). The second feature intermediate value (FI2) has a maximum value (1) when the rate of color change is a second reference value (F2). In contrast, when the rate of color change is between the first reference value (F1) and the second reference value (F2), the second feature intermediate value (FI2) has a value proportional to the rate of color change. When the rate of color change is between the second reference value (F2) and the third reference value (F3), the second feature intermediate value (FI2) has a value inversely proportional to the rate of color change.

The feature intermediate selector 146c compares the first feature intermediate value (FI1) and the second feature intermediate value (FI2) and outputs the larger value as the final feature halftone value (F1).

The image type determining unit 148 compares the final feature text value (FT), the final feature halftone value (FH), and the final feature intermediate value (F1). Based on the result of this comparison, the image type determining unit 148 classifies the type of images included in each image block. That is, the image type determining unit 148 classifies a selected image block as a text image if the feature text value (FT) is larger than the feature halftone value (FH) and the feature intermediate value (F1). The image type determiner 148 classifies a selected image block as a halftone image if the feature halftone value (FH) is larger than the feature text value (FT) and the feature intermediate value (F1). In any other case, the image type determiner 148 classifies a selected image block as an intermediate image.

The image isolating unit 150 isolates a halftone image from a binary image based on the classified image type. The image isolating unit 150 may use a Recursive XY cut algorithm to isolate halftone images from binary images. After isolating, the image isolating unit 150 outputs the isolated image to the compressing unit 160.

The compressing unit 160 comprises a first compressing unit 162 and a second compressing unit 164. The first compressing unit 162 is a module compressing text images from the image isolating unit 150. A symbol matching encoding algorithm is implemented in the first compressing unit 162. The algorithm specified in the Joint Bi-level Image experts Group-2 (JBIG2) standard may be used as the symbol matching encoding algorithm.

The second compressing unit 164 is a module for compressing halftone images from the image isolating unit 150. The second compressing unit 164 may use an algorithm based on one of a Modified READ (MR), a Modified Modified READ (MMR) or any other suitable halftone coding algorithm.

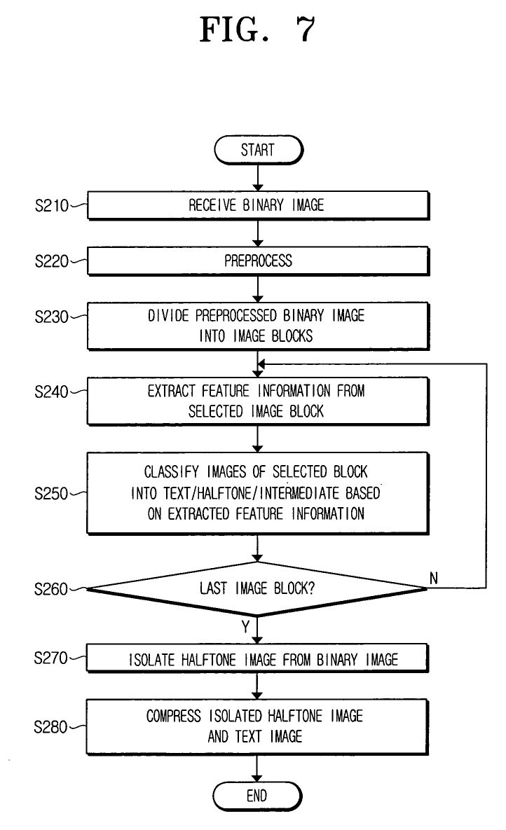

FIG. 7 is a flowchart showing the method for classifying images performed by the apparatus shown in FIG. 1. Referring to FIG. 7, when a target binary image is received from the scanner 110 at step S210, the preprocessor 120 preprocesses the received target binary image to filter noise and correct gradients at step S220.

The information extracting unit 130 divides the target binary image into a plurality of image blocks having a predetermined size at step S230. That is, the information extracting unit 130 divides the target binary image into non-overlapping image blocks as shown in FIG. 2. After dividing the image, the information extracting unit 130 extracts feature information from the images included in each of the image blocks at step S240. That is, the information extracting unit 130 extracts the number of the connected components and the rate of color change between image pixels from selected image blocks.

The image classifying unit 140 classifies a selected image block into a text image, a halftone image or an intermediate image based on the extracted information (such as the number of the connected components and the rate of color change) at step S250.

To explain in more detail, the first, the second and the third feature value outputting units 142, 144 and 146 generate the feature text value (FT), the feature halftone value (FH) and the feature intermediate value (F1). These values represent the amount of text images, halftone images or intermediate images included in a selected image block. The image type determiner 148 compares the feature text value (FT), the feature halftone value (FH) and the feature intermediate value (F1) and determines the type of images included in a selected image block based on the comparison. For example, the image type determiner 148 classifies a selected image block as a text image if the feature text value (FT) is larger than the feature halftone value (FH) and the feature intermediate value (F1). The image type determiner 148 classifies a selected image block as a halftone image if the feature halftone value (FH) is larger than the feature text value (FT) and the feature intermediate value (F1). The image type determiner 148 classifies a selected image block as an intermediate image in any other case.

The image classifying unit 140 determines whether the selected image block is the last image block at step S260. If the selected image block is not the last image block, the above-mentioned steps S240 to S250 are repeated for each single image block.

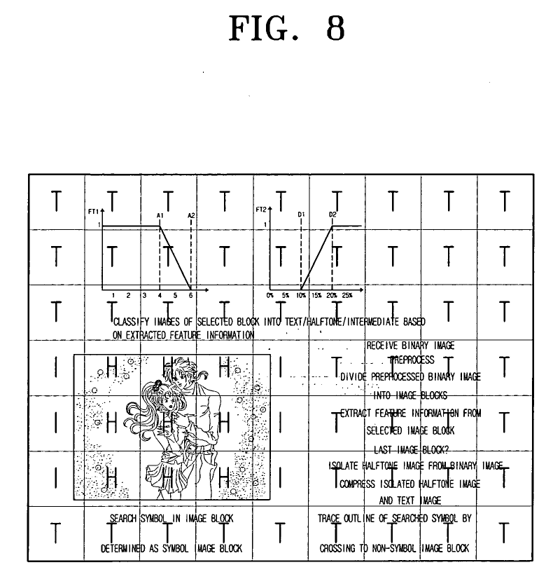

FIG. 8 shows a binary image having a plurality of image blocks labeled to represent the type of image in each image block. In FIG. 8, image blocks labeled with a reference sign “T” represent text image blocks. Image blocks labeled with reference sign “I” represent intermediate image blocks. Image blocks labeled with a reference sign “H” represents halftone image blocks.

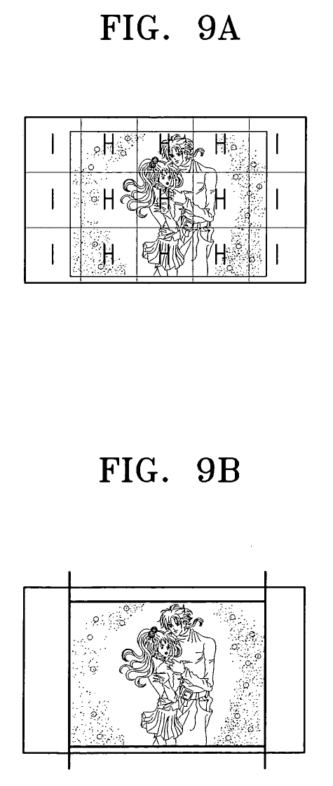

After determining the image type of all image blocks, the image isolating unit 150 segments the halftone images from the binary image at step S270. To do so, the image classifying unit 150 first creates an isolated image including the halftone images from the binary image. As shown in FIG. 9A, the isolated image includes both the halftone images and the intermediate images. Next, the image isolating unit 150 performs an algorithm such as a Recursive XY cut as shown in FIG. 9B to segment the halftone images from the isolated image. FIG. 10A is a view showing a binary image where the halftone images have been isolated and FIG. 10B shows the halftone image which has been isolated from the binary image.

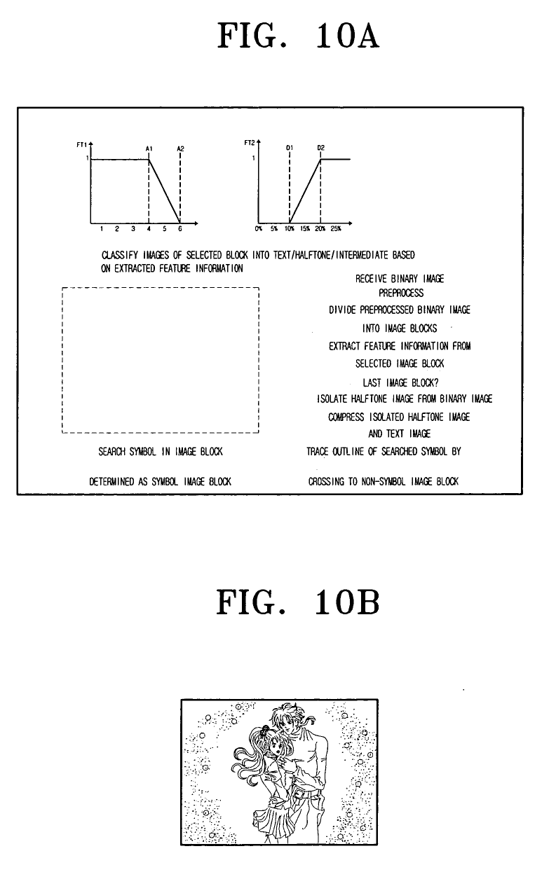

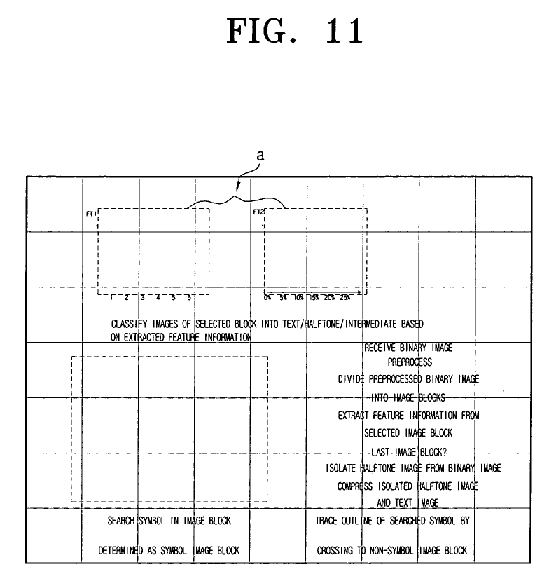

After isolating the halftone images, the image isolating unit 150 segments the binary image where the halftone images have been isolated into an image suitable for the symbol matching encoding method and another image unsuitable for the symbol matching encoding method based on a size of the connected components. FIG. 11 shows the binary image where images not suitable for a symbol matching encoding method have been isolated. Referring to FIG. 11, the images indicated by the reference sign ‘a’ are eliminated from the binary image of FIG. 10. The image isolating unit 150 transmits the images suitable for the symbol matching encoding method to the first compressing unit 162. That is, the image isolating unit 150 transmits text images to the first compressing unit 162. The image isolating unit 150 transmits the images unsuitable for the symbol matching encoding method to the second compressing unit 164. That is, the images having a large amount of connected components are transmitted to the second compressing unit 164. The images having a large amount of connected components may be compressed by using another compression algorithm, or, the isolated image may be combined with the halftone images and compressed by using identical compression algorithm.

Finally, the text images and the halftone images are transmitted to the first and the second compressing units 162 and 164 at step S280. That is, the text images are compressed by the first compressing unit 162 by a compression algorithm based on the symbol matching encoding method and the halftone images are compressed by the second compressing unit 164 by a compression algorithm based on one of the JBIG, MMR, or MR algorithms.

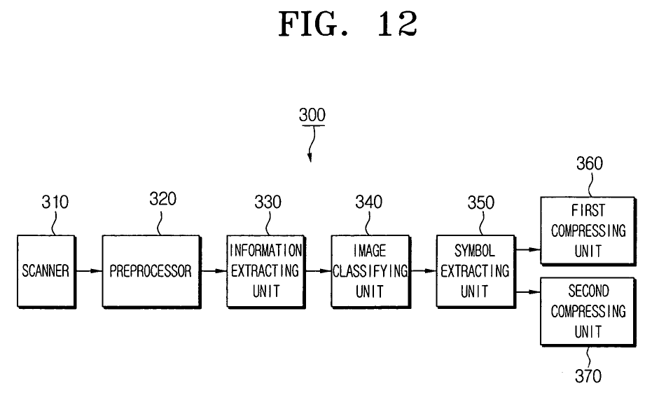

FIG. 12 is a block diagram illustrating an apparatus for processing a binary image in accordance with a second embodiment of the present invention.

Referring to FIG. 12, the apparatus 300 for processing the binary image comprises a scanner 310, a preprocessor 320, an information extracting unit 330, an image classifying unit 340, a symbol extracting unit 350, a first compressing unit 360 and a second compressing unit 370. The apparatus 300 extracts symbols suitable for a symbol matching encoding method from a binary image in order to effectively encode the binary image scanned by an image scanning apparatus such as the scanner 310.

The scanner 310 scans a target document to generate a binary image and converts the binary image to a digital signal. The scanner 310 outputs the digital signal to the preprocessor 320. The preprocessor 320 preprocesses the binary image by performing such processes as noise filtering and gradient correction.

The information extracting unit 330 divides the preprocessed binary image into a plurality of image blocks having a predetermined size. The information extracting unit 330 also extracts feature information from each of the image blocks. The extracted feature information includes the number of connected components in an image block and the rate of color change between image pixels in an image block. The information extracting unit 330 outputs the extracted information to the image classifying unit 340.

The image classifying unit 340 determines whether the images in an image block are symbol images or non-symbol images based on the extracted information. A symbol image is an image such as text, signs, or numbers. A non-symbol image is an image such as a halftone image. In the present invention, if an image is not classified as a symbol image, the image is classified as a non-symbol image.

The symbol extracting unit 350 searches symbols included in the binary image. That is, the symbol extracting unit 350 searches symbols in image blocks classified as a symbol image block. When a symbol is detected from a symbol image block, the symbol extracting unit 350 traces an outline of the symbol. After tracing the outline of the symbol, the symbol extracting unit 350 extracts the symbol from the symbol image block. During the tracing, if it is determined that the outline of the symbol is included in a non-symbol image block, the symbol extracting unit 350 traces the outline by crossing into the non-symbol image block. Accordingly, the present invention extracts not only symbols in a symbol image block but also symbols located on a boundary between a symbol image block and a non-symbol image block. However, symbols in a non-symbol image block are not extracted. The symbols extracted by the symbol extracting unit 350 are output to the first compressing unit 360.

The first compressing unit 360 is a module that compresses the extracted symbols from the symbol extracting unit 350 by using a symbol matching encoding algorithm. The algorithm specified in the Joint Bi-level Image experts Group-2 (JBIG2) standard may be used as the symbol matching encoding algorithm.

The second compressing unit 370 is a module that compresses a symbol extracted image. That is, images included in a non-symbol image block are compressed by the second compressing unit 370. The second compressing unit 370 may use an algorithm based on one of Modified READ (MR), Modified Modified READ (MMR) or any other suitable halftone coding algorithms.

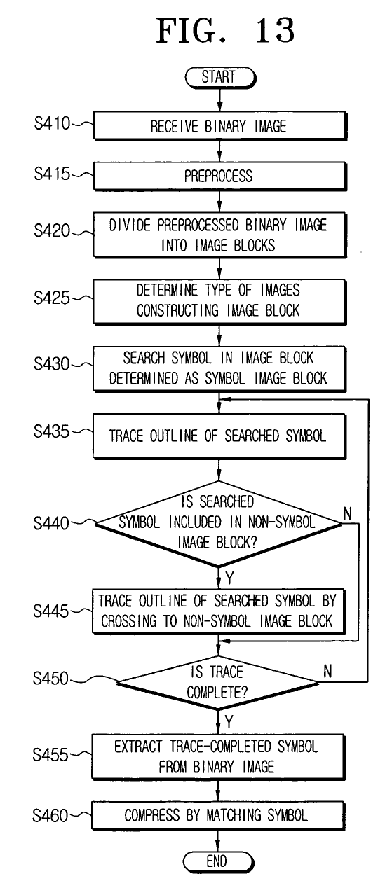

FIG. 13 is a flowchart showing a method for processing a binary image in accordance with an embodiment of the present invention. The method shown in FIG. 13 is used in the apparatus shown in FIG. 12. Referring to FIGS. 12 and 13, when a binary image is received from the scanner 310 at step S410, the preprocessor 320 preprocesses the received binary image to filter noise and correct gradients at step S415.

The information extracting unit 330 divides the preprocessed binary image into a plurality of image blocks at step S420 and extracts information from each of image blocks to determine the type of image forming each of image blocks. That is, the information extracting unit 330 extracts the number of connected components and the rate of color change between pixels in each image block.

The image classifying unit 340 determines whether the images constructing each image block are a symbol image or a non-symbol image based on the extracted information at step S425.

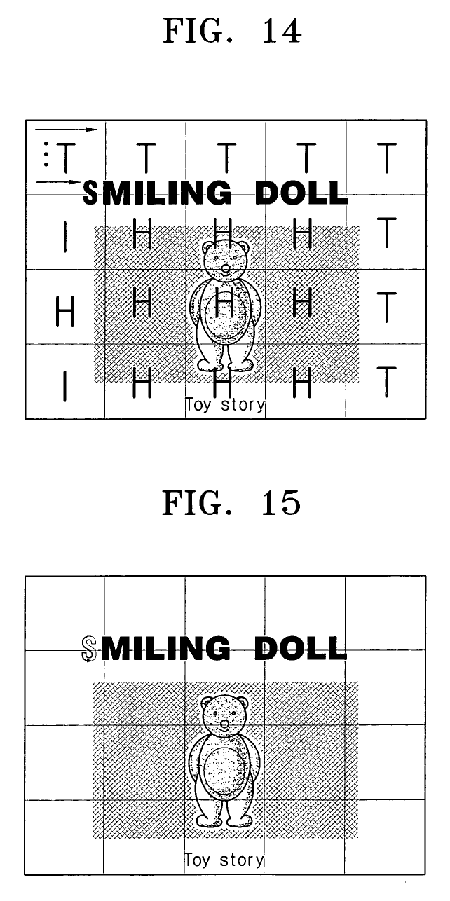

After determining the type of images included in the image blocks, the symbol extracting unit 350 searches symbols in symbol image blocks which are constructed with symbol images at step S430. The symbol extracting unit 350 searches the symbols in the symbol image blocks by scanning the symbol image blocks in a raster scanning direction as shown in FIG. 14. FIG. 14 is a view showing a binary image divided into a plurality of image blocks which are labeled based on the determination of the image determiner 340. As shown in FIG. 14, a reference letter “T” represents image blocks with text data. Reference letters “H” or “I” represents image blocks with halftone images or intermediate images, respectively.

When a symbol is detected in the step S430, the symbol extracting unit 350 traces an outline of the detected symbol in a predetermined direction, preferably, a clockwise direction, at step S435. If the detected symbol is located at a boundary between a symbol image block and a non-symbol image block at step S440, the symbol extracting unit 350 traces the outline of the symbol by crossing into the non-symbol image block at step S445. To illustrate, as shown in FIG. 15, when the detected symbol “S” is located at a boundary of the symbol image block and the non-symbol image block, the symbol extracting unit 350 traces the outline of the detected symbol “S” by crossing into the non-symbol image block.

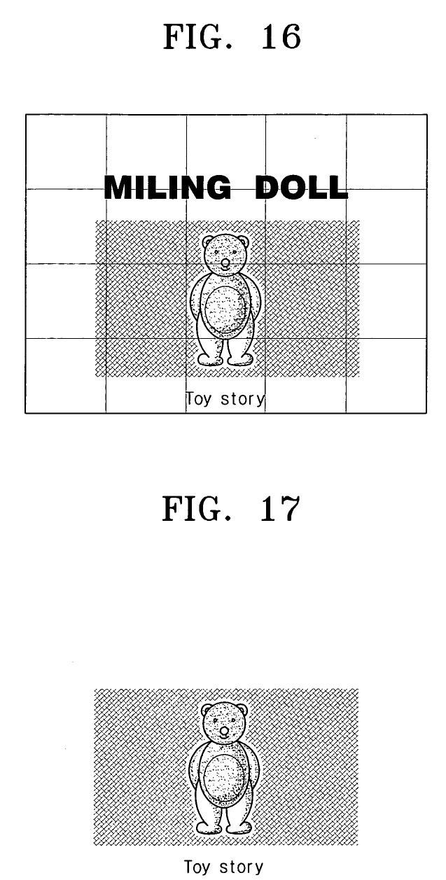

When the symbol extracting unit 350 finishes tracing the outline of the detected symbol at step S450, the symbol extracting unit 350 extracts the outline traced symbol from the binary image at step S455. FIG. 16 is a view showing a binary image where the outline traced symbol is extracted. As compared to FIG. 15, the binary image of FIG. 16 does not include the symbol “S”. After extracting the symbols from the binary image, the extracted symbols are transmitted to the first compressing unit 360.

The first compressing unit 360 compresses the extracted symbols by matching the extracted symbols to symbols registered in a dictionary at step S460. In more detail, it searches for symbols similar to the extracted symbol in the dictionary. If there are symbols similar to the extracted symbol, the extracted symbols are compressed by using an index to the similar symbols in the dictionary. If not, the extracted symbols are registered in the dictionary. When compressing extracted symbols, any space between the symbols is also compressed based on the location information of the extracted symbols.

Meanwhile, FIG. 17 shows a non-symbol image, that is, an image where the symbols have been extracted. The non-symbol image is compressed by the second compressing unit 370.

Thus, the present invention classifies images in a binary image into images suitable for the symbol matching method and images unsuitable for the symbol matching method and uses different compression algorithms according to the classification. Therefore, the compression rate is increased. Repeated computations and large amounts of memory are not required by the present invention. Therefore, the present invention may be implemented in a stand-alone device to effectively compress a binary image.

Furthermore, the present invention divides a binary image into symbol image blocks and non-symbol image blocks, extracts symbols included in the symbol image blocks and symbols located at the boundary between the symbol image blocks and the non-symbol image blocks, and compresses the extracted symbols. Therefore, the present invention performs accurate symbol matching and reduces singletons.

While the invention has been shown and described with reference to certain embodiments thereof, it will be understood by those skilled in the art that various changes in form and details may be made therein without departing from the spirit and scope of the invention as defined by the appended claims.

1. A method for processing a binary image, the method comprising the steps of:
a) dividing a binary image into a plurality of image blocks;
b) extracting feature information from each of the image blocks; and
c) classifying the type of image forming each of the image blocks by using the extracted feature information.

2. The method of claim 1, wherein, in step c), the images are classified as one of a text image or a halftone image.

3. The method of claim 2, further comprising the step of d) isolating images having halftone images from the binary image.

4. The method of claim 3, wherein the step of isolating the halftone images is performed using a Recursive XY Cut algorithm.

5. The method of claim 3, wherein the step d) comprises the steps of:
d-1) generating a first feature value representing the amount of text images in each of the image blocks based on the number of connected components and the rate of color change, and generating a second feature value representing the amount of halftone images in each of the image blocks based on the number of connected components and the rate of color change; and
d-2) comparing the first feature value and the second feature value.

6. The method of claim 5, wherein the images are classified as text images when the first feature value of the image block is larger than the second feature value, and the images are classified as halftone images when the first feature value of the image block is smaller than the second feature value.

7. The method of claim 6, wherein the first feature value is inversely proportional to the number of connected components and the rate of color change and the second feature value is proportional to the number of connected components and the rate of color change.

8. The method of claim 1, wherein the feature information includes the number of connected components included in each of the image blocks and a rate of color change between pixels in each of the image blocks.

9. An apparatus for processing a binary image, the apparatus comprising:
an information extracting unit for dividing a binary image received from an image source into a plurality of image blocks and extracting feature information from each of the image blocks; and
an image classifying unit for classifying the images forming each image block based on the extracted feature information.

10. The apparatus of claim 9, wherein the image classifying unit classifies the images forming each of the image blocks into one of a text image or a halftone image.

11. The apparatus of claim 10, further comprising an image isolating unit for isolating images having halftone images from the binary image.

12. The apparatus of claim 11, wherein the image isolating unit isolates the images having the halftone images by performing a Recursive XY Cut algorithm.

13. The apparatus of claim 9, wherein the information extracting unit extracts at least one of the number of connected components included in each of the image blocks or a rate of color change between pixels in each of the image blocks.

14. The apparatus of claim 13, wherein the image classifying unit comprises:
a first feature value outputting unit for generating a first feature value representing the amount of included text images in each of the image blocks based on the number of connected components and the rate of color change;
a second feature value outputting unit for generating a second feature value representing the amount of included halftone images in each of the image blocks based on the number of connected components and the rate of color change; and
an image type determining unit for comparing the first feature value and the second feature value and classifying the type of images included in each of the image blocks as a text image or a halftone image.

15. The apparatus of claim 14, wherein the image type determining unit classifies images of an image block having a first feature value larger than a second feature value as a text image, and classifies images of an image block having a first feature value smaller than a second feature value as a halftone image.

16. The apparatus of claim 15, wherein the first feature value is inversely proportional to the number of connected components and the rate of color change and the second feature value is proportional to the number of connected components and the rate of color change.

17. A method for processing a binary image, the method comprising the steps of:
a) dividing a binary image into a plurality of image blocks and classifying the images forming each of the image blocks into a symbol image and a non-symbol image;
b) searching a symbol in a symbol image block including the symbol images; and
c) tracing an outline of the searched symbol and extracting the symbol from the binary image when the tracing of the outline of the searched symbol is completed.

18. The method of claim 17, further comprising the step of d) determining whether a target symbol for tracing is included in a non-symbol image block having the non-symbol images and crossing into the non-symbol image block when the target symbol is included in the non-symbol image block.

19. The method of claim 18, further comprising the steps of:
e) searching a dictionary to find a symbol similar to the extracted symbol; and
f) registering the extracted symbol to the dictionary when a similar symbol is not in the dictionary.

20. An apparatus for processing a binary image, the apparatus comprising:
an information extracting unit for dividing a binary image into a plurality of image blocks and extracting feature information from each of the image blocks;
an image classifying unit for classifying the images forming each of the image blocks into a symbol image or a non-symbol image;
a symbol extracting unit for searching a symbol in a symbol image block having the symbol images, tracing an outline of the searched symbol, and extracting the symbol from the binary image when the tracing of the outline is completed.

21. The apparatus of claim 20, wherein the symbol extracting unit determines whether a target symbol for tracing is included in a non-symbol image block having the non-symbol images and traces an outline of the target symbol by crossing into the non-symbol image block when the target symbol is included in the non-symbol image block.
